(19) United States
(12) Patent Application Publication
(10) Pub. No.: US 2015/0263859 A1
(43) Pub. Date: Sep. 17, 2015

(54) METHOD AND SYSTEM FOR ACCOMMODATING COMMUNICATIONS CHANNELS USING DIFFERENT SECURE COMMUNICATIONS PROTOCOLS

(71) Applicant: Intuit Inc., Mountain View, CA (US)

(72) Inventors: M. Shannon Lietz, San Marcos, CA (US); Luis Felipe Cabrera, Bellevue, WA (US)

(73) Assignee: INTUIT INC., Mountain View, CA (US)

(21) Appl. No.: 14/215,432

(22) Filed: Mar. 17, 2014

(51) Int. Cl. H04L 9/32

(52) U.S. Cl. CPC H04L 9/32

(57) ABSTRACT

A communications protocol is selected to be used to transfer message data between a source computing entity and a destination computing entity. Encryption code data identifying the selected communications protocol is generated and associated with the message data. One or more communications endpoint proxy systems are provided that include an encryption code identification module and a communications protocol processing module for obtaining communications protocol processing data associated with first communications protocol identified by encryption code data. The message data is transferred to the communications endpoint proxy and the communications protocol processing data associated with communications protocol identified by encryption code data is obtained and used to process the message data which is then transferred to the destination computing entity.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners and operators of data centers that provide access to data and other resources are extremely hesitant to allow their data and resources to be accessed, processed, and/or otherwise used, by virtual assets in the cloud.

In order to provide more security in a cloud computing environment, it would be desirable to provide multiple types and degrees of secure communications protocols for transferring data between computing entities. In addition, in order to more efficiently process data and communications, it is also desirable to provide various communications endpoint proxy systems, such as, but not limited to, load balancers, to both regulate and distribute communications and processing traffic and to act as a mechanism for performing various functions such as decryption, e.g., act as proxies for secure communications protocol endpoints, in a relatively safe location before the message data is transferred to the actual endpoint, or destination, computing entities for processing.

Currently, some load balancers do perform both the load balancing and secure communications endpoint proxy message processing functions. However, these currently available systems are typically statically configured to only handle/process the Secure Sockets Layer (SSL) communications protocol. While this can be an effective system for the SSL communications protocol, many users of cloud-based computing systems desire the flexibility, and added security, provided by using multiple secure data transfer protocols, including those other that the SSL communications protocol. Despite this fact, as noted above, virtually all currently available communications endpoint proxy systems, e.g., currently available load balancers, only accommodate the SSL communications protocol.

What is needed is a communications endpoint proxy system that can perform both load balancing and secure communications endpoint proxy message processing functions for multiple secure data transfer protocols, including secure data transfer protocols other than the SSL communications protocol.

### SUMMARY

In accordance with one embodiment, a set of two or more communications protocols to be used to transfer message data between one or more source computing entities and one or more destination computing entities is provided. In one embodiment, a first communications protocol of the set of two or more communications protocols is selected to be used to transfer message data between a first source computing entity of the one or more source computing entities and a first destination computing entity of the one or more destination computing entities. In one embodiment, encryption code data identifying the selected first communications protocol to be used for transferring the message data between the first source computing entity and the first destination computing entity is generated and associated with the message data.

In one embodiment, at least one communications endpoint proxy system is provided that includes an encryption code identification capability for identifying the encryption code data associated with the message data and a communications protocol processing capability for obtaining communications protocol processing data associated with the first communications protocol identified by encryption code data. In one embodiment, the at least one communications endpoint proxy system is also capable of processing, or directing the processing of, the message data using the communications protocol processing data.

In one embodiment, the message data is transferred to the communications endpoint proxy system by the first source computing entity where the communications endpoint proxy system identifies the encryption code data. The communications endpoint proxy system then obtains the communications protocol processing data associated with communications protocol identified by encryption code data. In one embodiment, the message data is processed using the communications protocol processing data and the processed message data is then transferred to the first destination computing entity.

In accordance with one embodiment, a communications endpoint proxy routing system is provided that includes a security level identification capability for identifying a security level associated with received message data.

In one embodiment, two or more communications endpoint proxy systems are provided. In one embodiment, each of the communications endpoint proxy systems is associated with a defined security level of message data and includes a communications protocol processing capability for processing received message data using one or more specific communications protocols associated with that communications endpoint proxy system.

In one embodiment, message data is transferred from a source computing entity to the communications endpoint proxy routing system. In one embodiment, the security level identification capability of the communications endpoint proxy routing system is then used to identify a security level associated with the received message data. The communications endpoint proxy routing system is then used to select a first communications endpoint proxy system of the two or more communications endpoint proxy systems to receive the message data based on the security level associated with the message data and the assigned security level associated with the first communications endpoint proxy system.

In one embodiment, the message data is then transferred from the communications endpoint proxy routing system to the first communications endpoint proxy system. In one embodiment, the communications protocol processing capability of the first communications endpoint proxy system is then used to process the received message data after which the processed message data is transferred to a destination computing entity.

### BRIEF DESCRIPTION OF THE DRAWINGS

FIG. 1 is a functional block diagram showing the interaction of various elements for implementing one embodiment;

FIG. 2 is a flow chart depicting a process for accommodating communications channels using different secure communications protocols in accordance with one embodiment;

FIG. 3 is a functional block diagram showing the interaction of various elements for implementing one embodiment; and

FIG. 4 is a flow chart depicting a process for accommodating communications channels using different secure communications protocols in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a method and system for accommodating communications channels using different secure communications protocols includes a process for accommodating communications channels using different secure communications protocols implemented, at least in part, by one or more computing systems and/or computing entities.

As used herein, the terms “computing system” and “computing entity”, include, but are not limited to, a virtual asset; a server computing system; a workstation; a desktop computing system; a database system or storage cluster; a switching system; a router; any hardware system; any communications systems; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple virtual assets; server computing systems; workstations; desktop computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “virtual asset” includes any virtualized entity or resource, and/or part of an actual, or “bare metal” entity. In various embodiments, the virtual assets can be, but are not limited to, virtual machines, virtual servers, and instances implemented in a cloud computing environment; databases implemented, or associated with, a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

As used herein, the term “source computing entity” includes, but is not limited to, any computing system, and/or virtual asset, that is the sender of data, such as message data. As used herein, the term “destination computing entity” includes, but is not limited to, any computing system, and/or virtual asset, that is the receiver of data, such as message data. In various embodiments, a single computing system, and/or virtual asset, can be both a source computing entity and a destination computing entity in different scenarios.

In various embodiments, the one or more computing systems and computing entities implementing the processes for accommodating communications channels using different secure communications protocols are logically or physically located, and/or associated with, two or more computing environments. As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the components, infrastructure, communication and networking systems, and security systems associated with the computing systems and/or virtual assets making up the trusted computing environment, are either under the control of, or known to, a party. In contrast, unknown, or untrusted computing environments are environments and systems where the components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party.

Examples of trusted computing environments include the components making up data centers associated with, and/or controlled by, a party and/or any computing systems and/or virtual assets, and/or networks of computing systems and/or virtual assets, associated with, known by, and/or controlled by, a party. Examples of untrusted computing environments include, but are not limited to, public networks, such as the Internet, various cloud-based computing environments, and various other forms of distributed computing systems.

It often the case that a party desires to transfer data to, and/or from, a first computing environment that is an untrusted computing environment, such as, but not limited to, a public cloud, a virtual private cloud, and a trusted computing environment, such as, but not limited to, networks of computing systems in a data center controlled by, and/or associated with, the party. However, in other situations a party may wish to transfer data between two trusted computing environments, and/or two untrusted computing environments.

In one embodiment, two or more computing systems and/or virtual assets, and/or two or more computing environments, are connected by one or more communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more computing systems and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In one embodiment, a cloud computing environment is provided. In various embodiments, the provided cloud computing environment can be any form of cloud computing environment, such as, but not limited to, a public cloud; a private cloud; a virtual private network (VPN); a subnet; a Virtual Private Cloud, or VPC; a sub-net or any security/communications grouping; or any other cloud-based infrastructure, sub-structure, or architecture, as discussed herein, and/or as known in the art at the time of filing, and/or as developed after the time of filing.

In many cases, a given application or service provided through a cloud computing infrastructure may utilize, and interface with, multiple cloud computing environments, such multiple VPCs, in the course of providing the associated service. In various embodiments, each cloud computing environment includes allocated virtual assets associated with, and controlled or used by, the party utilizing the cloud computing environment.

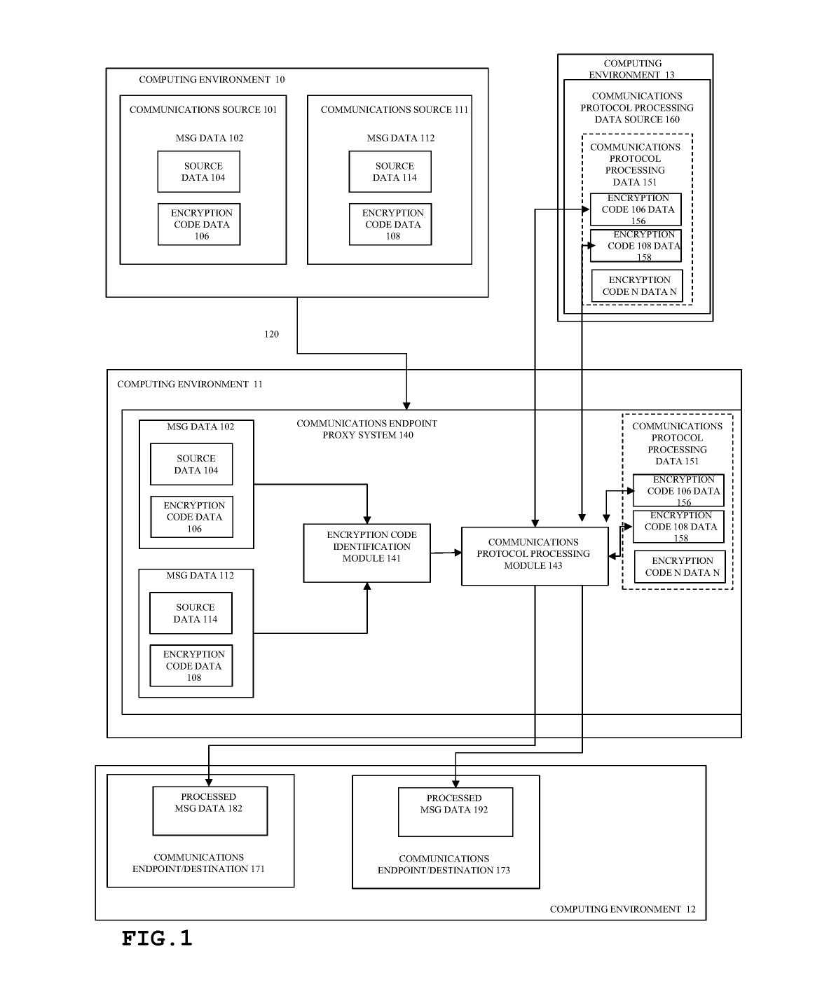

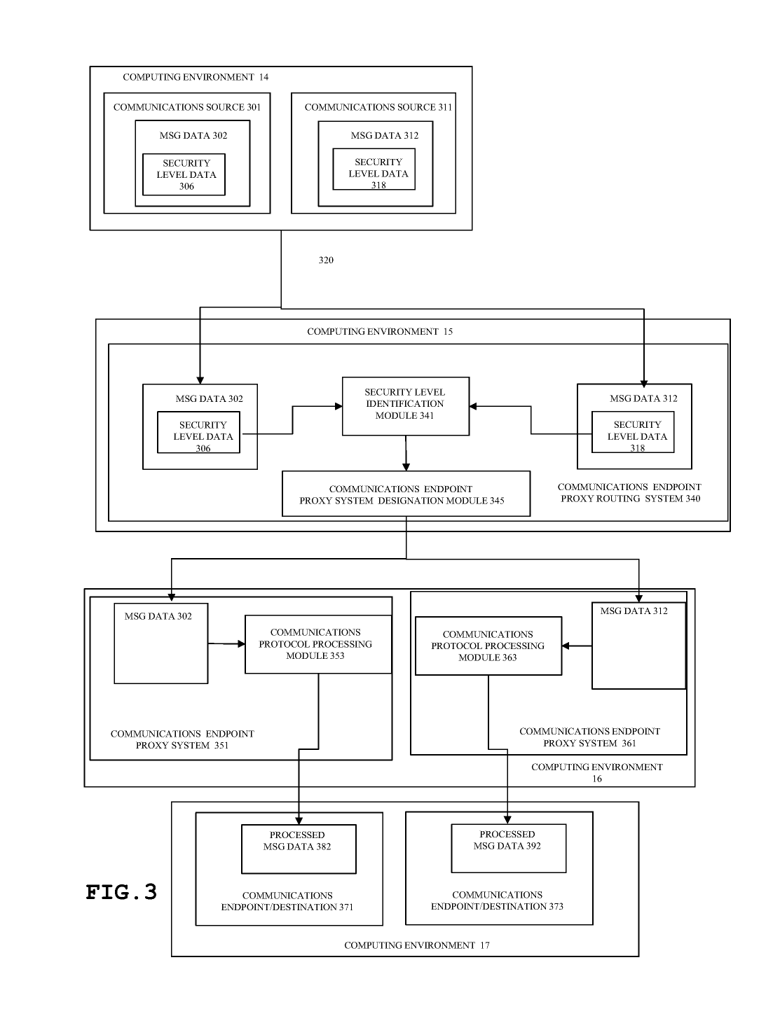

FIG. 1 and FIG. 3 are functional diagrams of the interaction of various elements associated with exemplary embodiments of the methods and systems for accommodating communications channels using different secure communications protocols discussed herein. Of particular note, the various elements in FIG. 1 are shown for illustrative purposes as being associated with specific computing environments, such as computing environments 10, 11, 12 and 13. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1, and/or the computing environments, systems and architectural and/or infrastructure components, deploying the elements shown in FIG. 1, can be under the control of, or otherwise associated with, various parties or entities, or multiple parties or entities, such as, but not limited to, the owner of a data center, a party and/or entity providing all or a portion of a cloud-based computing environment, the owner or a provider of a service, the owner or provider of one or more resources, and/or any other party and/or entity providing one or more functions, and/or any other party and/or entity as discussed herein, and/or as known in the art at the time of filing, and/or as made known after the time of filing.

Likewise, the various elements in FIG. 3 are shown for illustrative purposes as being associated with specific computing environments, such as computing environments 14, 15, 16 and 17. However, the exemplary placement of the various elements within these environments and systems in FIG. 3 is made for illustrative purposes only and, in various embodiments, any individual element shown in FIG. 3, or combination of elements shown in FIG. 3, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components as discussed herein, and/or as known in the art at the time of filing, and/or as developed/made available after the time of filing.

In addition, the elements shown in FIG. 3, and/or the computing environments, systems and architectural and/or infrastructure components, deploying the elements shown in FIG. 3, can be under the control of, or otherwise associated with, various parties or entities, or multiple parties or entities, such as, but not limited to, the owner of a data center, a party and/or entity providing all or a portion of a cloud-based computing environment, the owner or a provider of a service, the owner or provider of one or more resources, and/or any other party and/or entity providing one or more functions or services, and/or any other party and/or entity as discussed herein, and/or as known in the art at the time of filing, and/or as made known after the time of filing.

In accordance with one embodiment, a set of two or more communications protocols to be used to transfer message data between one or more source computing entities and one or more destination computing entities is provided.

As discussed above, in order to provide more security in a cloud computing environment, it is desirable to provide multiple secure communications protocols for transferring data between computing entities. In addition, in order to more efficiently process data and communications, it is also desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

Currently, some load balancers do perform both the load balancing and secure communications endpoint proxy message processing functions. However, these currently available systems are typically statically configured to only handle/process the Secure Sockets Layer (SSL) communications protocol. While this can be an effective system for the SSL communications protocol, many users of cloud-based computing systems desire the flexibility, and added security, provided by using multiple secure data transfer protocols, including those other that the SSL communications protocol. Despite this fact, as noted above, virtually all currently available communications endpoint proxy systems, e.g., currently available load balancers, accommodate only the SSL communications protocol.

To address this issue, in one embodiment, a set of two or more communications protocols are provided for use with the method and system for accommodating communications channels using different secure communications protocols. In addition, in one embodiment, the set of two or more communications protocols is open ended and can be added to, or customized, by a given party so long as the selected communications protocol is identified to the system by encryption code data, as discussed below, and communications protocol processing data for processing messages sent using the communications protocol is provided, as also discussed below.

Examples of possible communications protocols to be included in the two or more communications protocols provided for use with the method and system for accommodating communications channels using different secure communications protocols include, but are not limited to, the Internet Protocol (IP); the User Datagram Protocol (UDP); the Transmission Control Protocol (TCP); the Simple Message Transmission Protocol (SMTP); the Internet Control Message Protocol (ICMP); the HyperText Transfer Protocol (HTTP); the Secure HyperText Transfer Protocol (HTTPS); the File Transfer Protocol (FTP); the Post Office Protocol (POP3); the Internet Message Access Protocol (IMAP); any Open Systems Interconnection (OSI) model protocol; the Secure Sockets Layer (SSL) protocol; and/or any other communications protocols as discussed herein, and/or as known in the art at the time of filing, and/or as become known or available after the time of filing.

As noted above, as used herein, the term “source computing entity” includes, but is not limited to, any computing system, and/or virtual asset, that is the sender, or origin, of data, such as message data. As used herein, the term “destination computing entity” includes, but is not limited to, any computing system, and/or virtual asset, that is the receiver, or endpoint, of data, such as message data. In various embodiments, a single computing system, and/or virtual asset, can be both a source computing entity and a destination computing entity in different scenarios.

In one embodiment, each communications channel for transferring data, e.g., message data, between a specific source computing entity and a specific destination computing entity is assigned a specific communications protocol. Consequently, in one embodiment, a first communications protocol of the set of two or more communications protocols is selected to be used to transfer message data between a first source computing entity of the one or more source computing entities and a first destination computing entity of the one or more destination computing entities.

In one embodiment, encryption code data identifying the selected first communications protocol to be used for transferring the message data between the first source computing entity and the first destination computing entity is generated and associated with the message data.

In some embodiments, the encryption code data identifying the selected first communications protocol is generated and associated with the message data by including the encryption code data as part of the message data header.

In some embodiments, the encryption code data identifying the selected first communications protocol is generated and associated with the message data by including the encryption code data as part of the data packet headers.

In some embodiments, the encryption code data identifying the selected first communications protocol is generated and associated with the message data by sending pre-communications data to the communications endpoint proxies, and/or the communications endpoint proxy routing systems, discussed below.

In various embodiments, the encryption code data identifying the selected first communications protocol is generated and associated with the message data using any procedure, process, mechanism, or system for identifying a communications protocol used with transferred data, such as message data, as discussed herein, and/or as known in the art at the time of filing, and/or as developed/made available after the time of filing.

As noted above, FIG. 1 is a functional diagram of the interaction of various elements associated with one embodiment of the methods and systems for accommodating communications channels using different secure communications protocols discussed herein. In particular, FIG. 1 shows communications sources 101 and 111 implemented, in this specific illustrative example, in computing environment 10.

As seen in FIG. 1, communications source 101 includes message data, represented as MSG data 102 in FIG. 1, source data 104, and encryption code data 106. Likewise, communications source 111 includes message data, represented as MSG data 112 in FIG. 1, source data 114, and encryption code data 108.

In one embodiment, message data 102 and message data 112 represent message data to be transferred between source entities, i.e., communications source 101 and communications source 111, and destination entities, i.e., communications and endpoint/destination 171 and communications endpoint/destination 173.

In one embodiment, source data 104 and source data 114 represent data indicating the source of message data 102 and message data 112, i.e., communications source 101 and communication source 111.

In one embodiment, encryption code data 106 represents data indicating the specific communications protocol, e.g., a first protocol, used to process message data 102. Likewise, encryption code data 108 represents data indicating another specific communications protocol used to process message data 112.

As seen in FIG. 1, in one embodiment, communications channel 120 is used to transfer message data 102 from communications source 101, and/or message data 112 from communications source 111, to communications endpoint proxy system 140.

In one embodiment, at least one communications endpoint proxy system is provided. In one embodiment, the communications endpoint proxy system is any system that is designed to receive data being transferred between a source computing entity and a destination computing entity, but is not the actual destination entity.

In one embodiment, the communications endpoint proxy system is a modified, or multiple protocol enabled, load balancer. As noted above, in order to more efficiently process data and communications, it is desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

As also noted above, currently load balancers are typically statically configured to only handle/process the Secure Sockets Layer (SSL) communications protocol. While this can be an effective system for the SSL communications protocol, many users of cloud-based computing systems desire the flexibility, and added security, provided by using multiple secure data transfer protocols, including those other that the SSL communications protocol. Despite this fact, as noted above, virtually all currently available communications endpoint proxy systems, e.g., currently available load balancers, accommodate only the SSL communications protocol.

To address this issue, each of the one or more communications endpoint proxy systems provided includes an encryption code identification module for identifying the encryption code data associated with the message data and a communications protocol processing module for obtaining communications protocol processing data associated with the first communications protocol identified by encryption code data. In one embodiment, each of the one or more communications endpoint proxy systems is implemented in software, hardware, or a combination of hardware and software.

Returning to FIG. 1, communications endpoint proxy system 140 is shown as implemented, in this one illustrative example, in the computing environment 11.

As seen in FIG. 1, and as discussed above, communications channel 120 is used to transfer message data 102 from communications source 101, and/or message data 112 from communications source 111, to communications endpoint proxy system 140.

As also seen in FIG. 1, communications endpoint proxy system 140 includes encryption code identification module 141 and communications protocol processing module 143.

In one embodiment, encryption code identification module 141 of communications endpoint proxy system 140 is used to identify and read encryption code data 106 and/or encryption code data 108 indicating the selected communications protocol used with message data 102 and 112, respectively, received by communications endpoint proxy system 140.

In one embodiment, once encryption code data 106 and/or encryption code data 108 is received and identified by encryption code identification module 141 of communications endpoint proxy system 140, encryption code data 106 and/or encryption code data 108 is transferred to communications protocol processing module 143 of communications endpoint proxy system 140.

In one embodiment, communications protocol processing module 143 of communications endpoint proxy system 140 then uses encryption code data 106 and/or encryption code data 108 of communications protocol processing data 151 to identify the selected communications protocol and obtain communications protocol processing data, represented by encryption code 106 data 156 and encryption code 108 data 158 associated with the selected communications protocol, e.g., obtain communications protocol processing data indicating how to process/decode message data 102 and/or message data 112 encoded using the selected communications protocol.

In one embodiment, communications protocol processing data 151 is transferred to, and stored, on, or under the control of, communications protocol processing module 143 of communications endpoint proxy system 140.

In one embodiment, communications protocol processing data 151 is obtained by communications protocol processing module 143 of communications endpoint proxy system 140 from a communications protocol processing data source 160 outside communications protocol processing module 143, such as a data base, or data center, the source computing entity, or the destination computing entity, shown in this illustrative example as implemented in computing environment 13.

In one embodiment, communications protocol processing data 151 is obtained by communications protocol processing module 143 of communications endpoint proxy system 140 from a communications protocol processing data source 160 outside communications protocol processing module 143 maintained by a third party source or service outside communications protocol processing module 143, such as a digital certificate source or communications protocol provider.

In various embodiments, communications protocol processing data 151 is obtained by communications protocol processing module 143 of communications endpoint proxy system 140 from any source of communications protocol processing data as discussed herein, and/or as known in the art at the time of filing, and/or as developed/made available after the time of filing.

In one embodiment, once communications protocol processing module 143 of communications endpoint proxy system 140 obtains the correct communications protocol processing data 151 for the selected communications protocol identified by encryption code data 106 and/or encryption code data 108, communications protocol processing module 143 of communications endpoint proxy system 140 processes, or directs the processing of, message data 102 and/or message data 112 using the correct portions of communications protocol processing data 151, i.e., encryption code 106 data 156 and encryption code 108 data 158 associated with the selected communications protocol.

In one embodiment, the processing, e.g., decryption, of message data 102 and/or message data 112 using the correct portions of communications protocol processing data 151 is performed by communications protocol processing module 143 of communications endpoint proxy system 140 itself.

In one embodiment, the processing, e.g., decryption, of message data 102 and/or message data 112 using the correct portions of communications protocol processing data 151 is performed by a computing system or entity (not shown) outside communications protocol processing module 143 of communications endpoint proxy system 140, with communications protocol processing module 143 transferring message data 102 and/or message data 112 and/or the correct portion of communications protocol processing data 151 to one or more entities (not shown) outside communications protocol processing module 143.

In one embodiment, the message data to be transferred between the first source computing entity and the first destination computing entity is first transferred to a selected first communications endpoint proxy of the one or more communications endpoint proxies by the first source computing entity.

As noted above, at the first communications endpoint proxy, the first communications endpoint proxy encryption code identification module identifies the encryption code data associated with the message data.

As also noted above, in one embodiment, the communications protocol processing module of the first communications endpoint proxy system then uses the encryption code data associated with the message data to identify the selected first communications protocol and obtain first communications protocol processing data associated with the first communications protocol, e.g., obtain first communications protocol processing data indicating how to process/decode the message data encoded using the first communications protocol.

As noted above, in one embodiment, the communications protocol processing data is pre-deployed, or transferred to, and stored on, or under the control of, the communications protocol processing module of the first communications endpoint proxy system. In this embodiment, the first communications protocol processing data is simply identified and obtained from within the first communications endpoint proxy system.

As also noted above, in one embodiment, the first communications protocol processing data is obtained by the communications protocol processing module of the first communications endpoint proxy system from a source outside the communications protocol processing module, such as a database, or data center, the first source computing entity, or the first destination computing entity.

As noted above, in one embodiment, the first communications protocol processing data is obtained by the communications protocol processing module of the first communications endpoint proxy system from a third party source or service outside the communications protocol processing module, such as a digital certificate source or communications protocol provider.

In various embodiments, the first communications protocol processing data is obtained by the communications protocol processing module of the first communications endpoint proxy system from any source of communications protocol processing data as discussed herein, and/or as known in the art at the time of filing, and/or as developed/made available after the time of filing.

As discussed above, in one embodiment, once the communications protocol processing module of the first communications endpoint proxy system obtains the correct first communications protocol processing data for the selected first communications protocol identified by the encryption code data associated with the message data, the communications protocol processing module of the first communications endpoint proxy system processes, or directs the processing of, the message data using the first communications protocol processing data.

In one embodiment, the processing, e.g., decryption, of the message data using the first communications protocol processing data is performed by the communications protocol processing module of the first communications endpoint proxy system itself.

In one embodiment, the processing, e.g., decryption, of the message data using the first communications protocol processing data is performed by a computing system or entity outside the communications protocol processing module of the first communications endpoint proxy system, with the communications protocol processing module transferring the message data and/or the first communications protocol processing data to one or more entities outside the communications protocol processing module.

In one embodiment, once the message data is processed, e.g., decrypted, using the first communications protocol processing data, the processed message data, i.e., the decrypted message data, is transferred to the first destination computing entity.

Returning to FIG. 1, the processed message data, i.e., the decrypted message data, shown as processed MSG data 182 and processed MSG data 192, is provided to communications endpoint/destination 171 and communications endpoint/destination 173, shown in this illustrative example as implemented in computing environment 12.

Using the methods and systems for accommodating communications channels using different secure communications protocols discussed herein, a communications endpoint proxy system is provided that can perform secure communications endpoint proxy message processing functions for multiple secure data transfer protocols, including secure data transfer protocols other than the SSL communications protocol. Consequently, using the methods and systems for accommodating communications channels using different secure communications protocols discussed herein, the flexibility, and added security, provided by using multiple secure data transfer protocols, including those other that the SSL communications protocol, is provided.

In one embodiment, multiple communications endpoint proxy systems are provided with each communications endpoint proxy system being assigned a data processing security level such that a given communications endpoint proxy system is provided only message traffic of the data processing security level assigned to the communications endpoint proxy system. In this way, intermingling and potential cross traffic of data of different processing security levels is avoided.

In accordance with one embodiment, a communications endpoint proxy routing system is provided that includes a security level identification module for identifying a security level associated with received message data and a communications endpoint proxy system designation module for matching the identified security level associated with the received message data to a communications endpoint proxy system having the appropriate assigned processing security level.

In various embodiments, the communications endpoint proxy routing system can be any computing system or computing entity, implemented in hardware, software, or any combination of hardware and software, as discussed herein, and/or as known in the art at the time of filing, and/or as developed after the time of filing, capable of identifying a security level associated with received message data and matching the identified security level associated with the received message data to a communications endpoint proxy system having the appropriate assigned processing security level.

As noted above, FIG. 3 is a functional diagram of the interaction of various elements associated with one embodiment of the methods and systems for accommodating communications channels using different secure communications protocols discussed herein. In particular, FIG. 3 shows communications sources 301 and 311 implemented, in this specific illustrative example, in computing environment 14.

As seen in FIG. 3, communications source 301 includes message data, represented as MSG data 302 in FIG. 3, and security level data 306. Likewise, communications source 311 includes message data, represented as MSG data 312 in FIG. 3, and security level data 318.

In one embodiment, message data 302 and message data 312 represent message data to be transferred between source entities, i.e., communications source 301 and communications source 311, and destination entities, i.e., communications endpoint/destination 371 and communications endpoint/destination 373.

In one embodiment, security level data 306 and security level data 318 represent data indicating the level of security associated with message data 302 and message data 312.

As seen in FIG. 3, in one embodiment, communications channel 320 is used to transfer message data 302 from communications source 301, and/or message data 312 from communications source 312, to communications endpoint proxy routing system 340.

As seen in FIG. 3, communications endpoint proxy routing system 340 includes security level identification module 341 and communications endpoint proxy system designation module 345.

In one embodiment, two or more communications endpoint proxy systems are provided. In one embodiment, each of the communications endpoint proxy systems is associated with a defined security level of message data and includes a communications protocol processing module for processing received message data using one or more specific communications protocols associated with that communications endpoint proxy system.

Returning to FIG. 3, communications endpoint proxy systems 351 and 361 are shown as representative of any number of communications endpoint proxy systems desired, shown as implemented in this illustrative example in computing environment 16.

In one embodiment, message data is transferred from a source computing entity to the communications endpoint proxy routing system. In one embodiment, the security level identification module of the communications endpoint proxy routing system is then used to identify a security level associated with the received message data. The communications endpoint proxy routing system is then used to select a first communications endpoint proxy system of the two or more communications endpoint proxy systems to receive the message data based on the security level associated with the message data and the assigned security level associated with the first communications endpoint proxy system.

In one embodiment, the message data is then transferred from the communications endpoint proxy routing system to the first communications endpoint proxy system.

As seen in FIG. 3, communications endpoint proxy system 351 includes message data 302 transferred from communications endpoint proxy system designation module 345 in accordance with the security level data 306 identified by security level identification module 341 and the security level assigned to communications endpoint proxy system 351.

Similarly, communications endpoint proxy system 361 includes message data 312 transferred from communications endpoint proxy system designation module 345 in accordance with the security level data 318 identified by security level identification module 341 and the security level assigned to communications endpoint proxy system 361.

In one embodiment, the communications protocol processing module of the first communications endpoint proxy system is then used to process the received message data after which the processed message data is transferred to a destination computing entity.

Returning to FIG. 3, as noted above, communications endpoint proxy system 351 includes message data 302 transferred from communications endpoint proxy system designation module 345 in accordance with the security level data 306 identified by security level identification module 341 and the security level assigned to communications endpoint proxy system 351. Also seen in FIG. 3 is communications protocol processing module 353 which is used to process, e.g., decrypt, message data 302 to generate processed message data 382.

Similarly, communications endpoint proxy system 361 includes message data 312 transferred from communications endpoint proxy system designation module 345 in accordance with the security level data 318 identified by security level identification module 341 and the security level assigned to communications endpoint proxy system 361. Also seen in FIG. 3 is communications protocol processing module 363 which is used to process, e.g., decrypt, message data 312 to generate processed message data 392.

As also seen in FIG. 3, processed message data 382 and processed message data 392 are then transferred to communications endpoint/destination 371 and communications endpoint/destination 373, respectively.

Using the methods and systems for accommodating communications channels using different secure communications protocols discussed above, multiple communications endpoint proxy systems are provided with each communications endpoint proxy system being assigned a data processing security level such that a given communications endpoint proxy system is provided only message traffic of the data processing security level assigned to the communications endpoint proxy system. In this way, intermingling and potential cross traffic of data of different processing security levels is avoided.

In one embodiment, each of the two or more communications endpoint proxy systems is a communications endpoint proxy system similar to those discussed above with respect to FIG. 1. Consequently, in one embodiment, a set of two or more communications protocols are associated with each communications endpoint proxy system. In addition, in one embodiment, the set of two or more communications protocols is open ended and can be added to, or customized, by a given party so long as the selected communications protocol is identified to the system by encryption code data, as discussed below, and communications protocol processing data for processing messages sent using the communications protocol is provided, as also discussed below.

In one embodiment, each communications channel for transferring data, e.g., message data, between a specific source computing entity and a specific destination computing entity is assigned a specific communications protocol. Consequently, in one embodiment, a first communications protocol of the set of two or more communications protocols is selected to be used to transfer message data between a first source computing entity of the one or more source computing entities and a first destination computing entity of the one or more destination computing entities.

In one embodiment, at least one of the communications endpoint proxy systems is a modified, or multiple protocol enabled, load balancer. As noted above, in order to more efficiently process data and communications, it is desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

As also noted above, currently, load balancers are typically statically configured to only handle/process the Secure Sockets Layer (SSL) communications protocol.

To address this issue, in one embodiment, each of the two or more communications endpoint proxy systems provided includes an encryption code identification module for identifying the encryption code data associated with the message data and a communications protocol processing module for obtaining communications protocol processing data associated with the first communications protocol identified by encryption code data.

As discussed below, in one embodiment, the encryption code identification module of each of the communications endpoint proxy systems is used to identify and read the encryption code data indicating the selected communications protocol used with message data received by the communications endpoint proxy system. In one embodiment, once the encryption code data is received and identified by encryption code identification module of the communications endpoint proxy system, the encryption code data is transferred to the communications protocol processing module of the communications endpoint proxy system.

As also discussed below, in one embodiment, the communications protocol processing modules of each of the communications endpoint proxy systems then uses the encryption code data to identify the selected communications protocol and obtain communications protocol processing data associated with the selected communications protocol, e.g., obtain communications protocol processing data indicating how to process/decode message data encoded using the selected communications protocol.

In one embodiment, the communications protocol processing data is transferred to, and stored, on, or under the control of, the communications protocol processing modules of the communications endpoint proxy systems.

In one embodiment, the communications protocol processing data is obtained by the communications protocol processing modules of the communications endpoint proxy systems from a source outside the communications protocol processing modules, such as a data base, or data center, the source computing entity, or the destination computing entity.

In one embodiment, the communications protocol processing data is obtained by the communications protocol processing modules of the communications endpoint proxy systems from a third party source or service outside the communications protocol processing module, such as a digital certificate source or communications protocol provider.

In various embodiments, the communications protocol processing data is obtained by the communications protocol processing modules of the communications endpoint proxy systems from any source of communications protocol processing data as discussed herein, and/or as known in the art at the time of filing, and/or as developed/made available after the time of filing.

In one embodiment, once the communications protocol processing modules of the communications endpoint proxy systems obtain the correct communications protocol processing data for the selected communications protocol identified by the encryption code data, the communications protocol processing modules of the communications endpoint proxy systems process, or direct the processing of, the message data using the correct communications protocol processing data.

In one embodiment, the processing, e.g., decryption, of the message data using the correct communications protocol processing data is performed by the communications protocol processing modules of the communications endpoint proxy systems.

In one embodiment, the processing, e.g., decryption, of the message data using the correct communications protocol processing data is performed by a computing system or entity outside the communications protocol processing modules of the communications endpoint proxy systems, with the communications protocol processing modules transferring the message data and/or the communications protocol processing data to one or more entities outside the communications protocol processing module.

In one embodiment, the message data to be transferred between the first source computing entity and the first destination computing entity is first transferred from the first source computing entity to the communications endpoint proxy routing system. In one embodiment, the security level identification module of the communications endpoint proxy routing system is then used to identify a security level associated with the received message data. The communications endpoint proxy routing system is then used to select a first communications endpoint proxy system of the two or more communications endpoint proxy systems to receive the message data based on the security level associated with the message data and the assigned security level associated with the first communications endpoint proxy system.

In one embodiment, the message data is then transferred from the communications endpoint proxy routing system to the selected first communications endpoint proxy of the one or more communications endpoint proxies. As noted above, at the first communications endpoint proxy, the first communications endpoint proxy encryption code identification module identifies the encryption code data associated with the message data.

As also noted above, in one embodiment, the communications protocol processing module of the first communications endpoint proxy system then uses the encryption code data associated with the message data to identify the selected first communications protocol and obtain first communications protocol processing data associated with the first communications protocol, e.g., obtain first communications protocol processing data indicating how to process/decode the message data encoded using the first communications protocol.

As noted above, in one embodiment, the communications protocol processing data is pre-deployed, or transferred to, and stored on, or under the control of, the communications protocol processing module of the first communications endpoint proxy system. In this embodiment, the first communications protocol processing data is simply identified and obtained from within the communications protocol processing module of the first communications endpoint proxy system.

As also noted above, in one embodiment, the first communications protocol processing data is obtained by the communications protocol processing module of the first communications endpoint proxy system from a source outside the communications protocol processing module, such as a database, or data center, the first source computing entity, or the first destination computing entity.

As noted above, in one embodiment, the first communications protocol processing data is obtained by the communications protocol processing module of the first communications endpoint proxy system from a third party source or service outside the communications protocol processing module, such as a digital certificate source or communications protocol provider.

In various embodiments, the first communications protocol processing data is obtained by the communications protocol processing module of the first communications endpoint proxy system from any source of communications protocol processing data as discussed herein, and/or as known in the art at the time of filing, and/or as developed/made available after the time of filing.

As discussed above, in one embodiment, once the communications protocol processing module of the first communications endpoint proxy system obtains the correct first communications protocol processing data for the selected first communications protocol identified by the encryption code data associated with the message data, the communications protocol processing module of the first communications endpoint proxy system processes, or directs the processing of, the message data using the first communications protocol processing data.

In one embodiment, the processing, e.g., decryption, of the message data using the first communications protocol processing data is performed by the communications protocol processing module of the first communications endpoint proxy system itself.

In one embodiment, the processing, e.g., decryption, of the message data using the first communications protocol processing data is performed by a computing system or entity outside the communications protocol processing module of the first communications endpoint proxy system, with the communications protocol processing module transferring the message data and/or the first communications protocol processing data to one or more entities outside the communications protocol processing module.

In one embodiment, once the message data is processed, e.g., decrypted, using the first communications protocol processing data, the processed message data, i.e., the decrypted message data, is transferred to the first destination computing entity.

Using the methods and systems for accommodating communications channels using different secure communications protocols discussed above, multiple communications endpoint proxy systems are provided with each communications endpoint proxy system being assigned a data processing security level such that a given communications endpoint proxy system is provided only message traffic of the data processing security level assigned to the communications endpoint proxy system. In this way, intermingling and potential cross traffic of data of different processing security levels is avoided.

In addition, in one embodiment, each communications endpoint proxy system can perform secure communications endpoint proxy message processing functions for multiple secure data transfer protocols, including secure data transfer protocols other than the SSL communications protocol. Consequently, using the methods and systems for accommodating communications channels using different secure communications protocols discussed herein, the flexibility, and added security, provided by using multiple secure data transfer protocols, including those other that the SSL communications protocol, is provided.

### Process

In accordance with one embodiment, a set of two or more communications protocols to be used to transfer message data between one or more source computing entities and one or more destination computing entities is provided. In one embodiment, a first communications protocol of the set of two or more communications protocols is selected to be used to transfer message data between a first source computing entity of the one or more source computing entities and a first destination computing entity of the one or more destination computing entities. In one embodiment, encryption code data identifying the selected first communications protocol to be used for transferring the message data between the first source computing entity and the first destination computing entity is generated and associated with the message data.

In one embodiment, at least one communications endpoint proxy system is provided that includes an encryption code identification capability for identifying the encryption code data associated with the message data and a communications protocol processing capability for obtaining communications protocol processing data associated with the first communications protocol identified by encryption code data. In one embodiment, the at least one communications endpoint proxy system is also capable of processing, or directing the processing of, the message data using the communications protocol processing data.

In one embodiment, the message data is transferred to the communications endpoint proxy system by the first source computing entity where the communications endpoint proxy system identifies the encryption code data. The communications endpoint proxy system then obtains the communications protocol processing data associated with communications protocol identified by encryption code data. In one embodiment, the message data is processed using the communications protocol processing data and the processed message data is then transferred to the first destination computing entity.

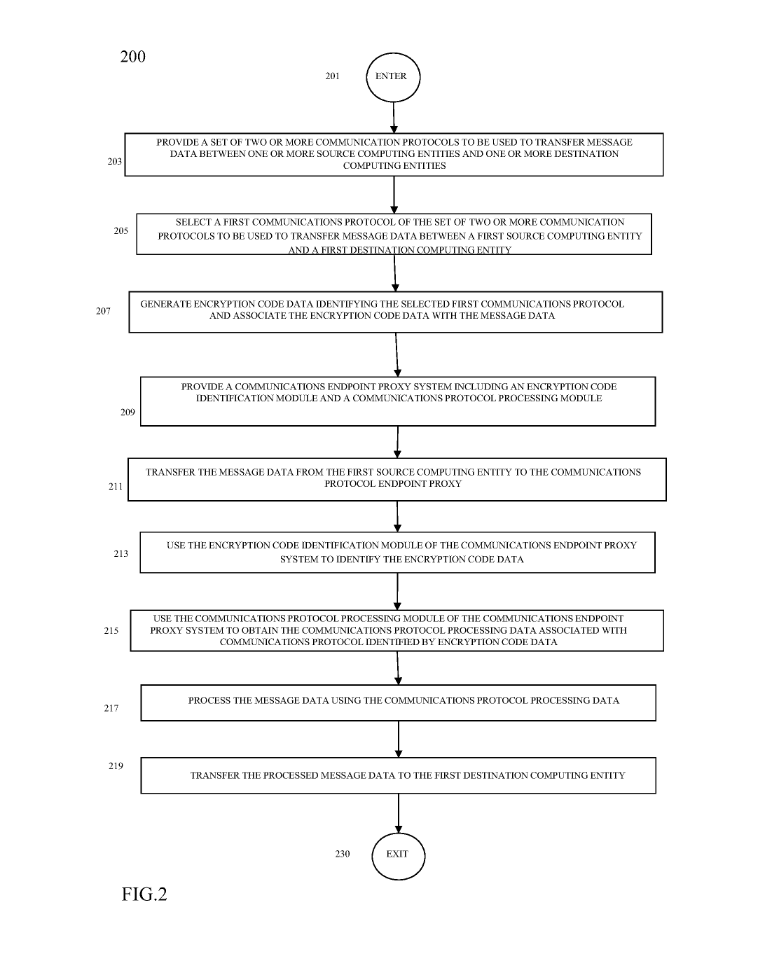

FIG. 2 is a flow chart of a process 200 for accommodating communications channels using different secure communications protocols in accordance with one embodiment. In one embodiment, process 200 for accommodating communications channels using different secure communications protocols begins at ENTER OPERATION 201 of FIG. 2 and process flow proceeds to PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203.

In one embodiment, at PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 a set of two or more communications protocols to be used to transfer message data between one or more source computing entities and one or more destination computing entities is provided.

As discussed above, in order to provide more security in a cloud computing environment, it is desirable to provide multiple secure communications protocols for transferring data between computing entities. In addition, in order to more efficiently process data and communications, it is also desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

Currently, some load balancers do perform both the load balancing and secure communications endpoint proxy message processing functions. However, these currently available systems are typically statically configured to only handle/process the Secure Sockets Layer (SSL) communications protocol. While this can be an effective system for the SSL communications protocol, many users of cloud-based computing systems desire the flexibility, and added security, provided by using multiple secure data transfer protocols, including those other that the SSL communications protocol. Despite this fact, as noted above, virtually all currently available communications endpoint proxy systems, e.g., currently available load balancers, accommodate only the SSL communications protocol.

To address this issue, in one embodiment, at PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 a set of two or more communications protocols.

In addition, in one embodiment, the set of two or more communications protocols of PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 is open ended and can be added to, or customized, by a given party so long as the selected communications protocol is identified to the system by encryption code data, as discussed below, and communications protocol processing data for processing messages sent using the communications protocol is provided, as also discussed below.

Examples of possible communications protocols to be included in the two or more communications protocols provided at PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 include, but are not limited to, the Internet Protocol (IP); the User Datagram Protocol (UDP); the Transmission Control Protocol (TCP); the Simple Message Transmission Protocol (SMTP); the Internet Control Message Protocol (ICMP); the HyperText Transfer Protocol (HTTP); the Secure HyperText Transfer Protocol (HTTPS); the File Transfer Protocol (FTP); the Post Office Protocol (POP3); the Internet Message Access Protocol (IMAP); any Open Systems Interconnection (OSI) model protocol; the Secure Sockets Layer (SSL) protocol; and/or any other communications protocols as discussed herein, and/or as known in the art at the time of filing, and/or as become known or available after the time of filing.

As noted above, as used herein, the term “source computing entity” includes, but is not limited to, any computing system, and/or virtual asset, that is the sender, or origin, of data, such as message data. As used herein, the term “destination computing entity” includes, but is not limited to, any computing system, and/or virtual asset, that is the receiver, or endpoint, of data, such as message data. In various embodiments, a single computing system, and/or virtual asset, can be both a source computing entity and a destination computing entity of PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 in different scenarios.

In one embodiment, once a set of two or more communications protocols to be used to transfer message data between one or more source computing entities and one or more destination computing entities is provided at PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203, process flow proceeds to SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205.

In one embodiment, each communications channel for transferring data, e.g., message data, between a specific source computing entity and a specific destination computing entity is assigned a specific communications protocol. Consequently, in one embodiment, at SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205 a first communications protocol of the set of two or more communications protocols of PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 is selected to be used to transfer message data between a first source computing entity of the one or more source computing entities of PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203 and a first destination computing entity of the one or more destination computing entities of PROVIDE A SET OF TWO OR MORE COMMUNICATIONS PROTOCOLS TO BE USED TO TRANSFER MESSAGE DATA BETWEEN ONE OR MORE SOURCE COMPUTING ENTITIES AND ONE OR MORE DESTINATION COMPUTING ENTITIES OPERATION 203.

In one embodiment, once a first communications protocol of the set of two or more communications protocols is selected to be used to transfer message data between a first source computing entity of the one or more source computing entities and a first destination computing entity of the one or more destination computing entities at SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205, process flow proceeds to GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207.

In one embodiment, at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 encryption code data identifying the selected first communications protocol to be used for transferring the message data between the first source computing entity and the first destination computing entity of SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205 is generated and associated with the message data.

In some embodiments, the encryption code data identifying the selected first communications protocol is generated and associated with the message data at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 by including the encryption code data as part of the message data header.

In some embodiments, the encryption code data identifying the selected first communications protocol is generated and associated with the message data at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 by including the encryption code data as part of the data packet headers.

In some embodiments, the encryption code data identifying the selected first communications protocol is generated and associated with the message data at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 by sending pre-communications data to the communications endpoint proxies, and/or the communications endpoint proxy routing systems, discussed below.

In various embodiments, the encryption code data identifying the selected first communications protocol is generated and associated with the message data at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 using any procedure, process, mechanism, or system for identifying a communications protocol used with transferred data, such as message data, as discussed herein, and/or as known in the art at the time of filing, and/or as developed/made available after the time of filing.

In one embodiment, once encryption code data identifying the selected first communications protocol to be used for transferring the message data between the first source computing entity and the first destination computing entity of SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205 is generated and associated with the message data at GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207, process flow proceeds to PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209.

In one embodiment, at PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 at least one communications endpoint proxy system is provided.

In one embodiment, the communications endpoint proxy system of PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 is any system that is designed to receive data being transferred between a source computing entity and a destination computing entity, but is not the actual destination entity.

In one embodiment, the communications endpoint proxy system of PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 is a modified, or multiple protocol enabled, load balancer.

As noted above, in order to more efficiently process data and communications, it is desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

As also noted above, currently load balancers are typically statically configured to only handle/process the Secure Sockets Layer (SSL) communications protocol. While this can be an effective system for the SSL communications protocol, many users of cloud-based computing systems desire the flexibility, and added security, provided by using multiple secure data transfer protocols, including those other that the SSL communications protocol. Despite this fact, as noted above, virtually all currently available communications endpoint proxy systems, e.g., currently available load balancers, accommodate only the SSL communications protocol.

To address this issue, each of the one or more communications endpoint proxy systems provided at PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 includes an encryption code identification module for identifying the encryption code data of GENERATE ENCRYPTION CODE DATA IDENTIFYING THE SELECTED FIRST COMMUNICATIONS PROTOCOL AND ASSOCIATE THE ENCRYPTION CODE DATA WITH THE MESSAGE DATA OPERATION 207 associated with the message data and a communications protocol processing module for obtaining communications protocol processing data associated with the first communications protocol identified by encryption code data.

In one embodiment, each of the one or more communications endpoint proxy systems of PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 is implemented in software, hardware, or a combination of hardware and software.

In one embodiment, once at least one communications endpoint proxy system is provided at PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209, process flow proceeds to TRANSFER THE MESSAGE DATA FROM THE FIRST SOURCE COMPUTING ENTITY TO THE COMMUNICATIONS PROTOCOL ENDPOINT PROXY OPERATION 211.

In one embodiment, at TRANSFER THE MESSAGE DATA FROM THE FIRST SOURCE COMPUTING ENTITY TO THE COMMUNICATIONS PROTOCOL ENDPOINT PROXY OPERATION 211 the message data to be transferred between the first source computing entity and the first destination computing entity is transferred to a selected first communications endpoint proxy of the one or more communications endpoint proxies of PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 by the first source computing entity of SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205.

In one embodiment, once the message data to be transferred between the first source computing entity and the first destination computing entity is transferred to a selected first communications endpoint proxy of the one or more communications endpoint proxies by the first source computing entity at TRANSFER THE MESSAGE DATA FROM THE FIRST SOURCE COMPUTING ENTITY TO THE COMMUNICATIONS PROTOCOL ENDPOINT PROXY OPERATION 211, process flow proceeds to USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213.

In one embodiment, at USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213 the first communications endpoint proxy encryption code identification module identifies the encryption code data associated with the message data.

In one embodiment, once the first communications endpoint proxy encryption code identification module identifies the encryption code data associated with the message data at USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213 the encryption code data is provided to the communications protocol processing module of the first communications endpoint proxy system.

In one embodiment, once the first communications endpoint proxy encryption code identification module identifies the encryption code data associated with the message data and the encryption code data is provided to the communications protocol processing module of the first communications endpoint proxy system at USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213, process flow proceeds to USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215.

In one embodiment, at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215 the communications protocol processing module of the first communications endpoint proxy system of PROVIDE A COMMUNICATIONS ENDPOINT PROXY SYSTEM INCLUDING AN ENCRYPTION CODE IDENTIFICATION MODULE AND A COMMUNICATIONS PROTOCOL PROCESSING MODULE OPERATION 209 uses the encryption code data associated with the message data of USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213 to identify the selected first communications protocol of SELECT A FIRST COMMUNICATIONS PROTOCOL OF THE SET OF TWO OR MORE COMMUNICATIONS PROTOCOLS TO BE USED TO TRANSFER MESSAGE DATA BETWEEN A FIRST SOURCE COMPUTING ENTITY AND A FIRST DESTINATION COMPUTING ENTITY OPERATION 205 and obtain first communications protocol processing data associated with the first communications protocol, e.g., obtain first communications protocol processing data indicating how to process/decode the message data encoded using the first communications protocol.

As noted above, in one embodiment, the communications protocol processing data is pre-deployed, or transferred to, and stored on, or under the control of, the communications protocol processing module of the first communications endpoint proxy system. In this embodiment, at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215 the first communications protocol processing data is simply identified and obtained from within the communications protocol processing module of the first communications endpoint proxy system.

As also noted above, in one embodiment, the first communications protocol processing data is obtained by the communications protocol processing module of the first communications endpoint proxy system at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215 from a source outside the communications protocol processing module, such as a database, or data center, the first source computing entity, or the first destination computing entity.

As noted above, in one embodiment, the first communications protocol processing data is obtained by the communications protocol processing module of the first communications endpoint proxy system at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215 from a third party source or service outside the communications protocol processing module, such as a digital certificate source or communications protocol provider.

In various embodiments, the first communications protocol processing data is obtained by the communications protocol processing module of the first communications endpoint proxy system at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215 from any source of communications protocol processing data as discussed herein, and/or as known in the art at the time of filing, and/or as developed/made available after the time of filing.

In one embodiment, once the communications protocol processing module of the first communications endpoint proxy system uses the encryption code data associated with the message data to identify the selected first communications protocol and obtain first communications protocol processing data associated with the first communications protocol at USE THE COMMUNICATIONS PROTOCOL PROCESSING MODULE OF THE COMMUNICATIONS ENDPOINT PROXY SYSTEM TO OBTAIN THE COMMUNICATIONS PROTOCOL PROCESSING DATA ASSOCIATED WITH COMMUNICATIONS PROTOCOL IDENTIFIED BY ENCRYPTION CODE DATA OPERATION 215, process flow proceeds to PROCESS THE MESSAGE DATA USING THE COMMUNICATIONS PROTOCOL PROCESSING DATA OPERATION 217.

In one embodiment, once the communications protocol processing module of the first communications endpoint proxy system obtains the correct first communications protocol processing data for the selected first communications protocol identified by the encryption code data associated with the message data, the communications protocol processing module of the first communications endpoint proxy system processes, or directs the processing of, the message data using the first communications protocol processing data at PROCESS THE MESSAGE DATA USING THE COMMUNICATIONS PROTOCOL PROCESSING DATA OPERATION 217.

In one embodiment, the processing, e.g., decryption, of the message data using the first communications protocol processing data is performed at PROCESS THE MESSAGE DATA USING THE COMMUNICATIONS PROTOCOL PROCESSING DATA OPERATION 217 by the communications protocol processing module of the first communications endpoint proxy system itself.

In one embodiment, at PROCESS THE MESSAGE DATA USING THE COMMUNICATIONS PROTOCOL PROCESSING DATA OPERATION 217 the processing, e.g., decryption, of the message data using the first communications protocol processing data is performed by a computing system or entity outside the communications protocol processing module of the first communications endpoint proxy system, with the communications protocol processing module transferring the message data and/or the first communications protocol processing data to one or more entities outside the communications protocol processing module.

In one embodiment, once the communications protocol processing module of the first communications endpoint proxy system processes, or directs the processing of, the message data using the first communications protocol processing data at PROCESS THE MESSAGE DATA USING THE COMMUNICATIONS PROTOCOL PROCESSING DATA OPERATION 217, process flow proceeds to TRANSFER THE PROCESSED MESSAGE DATA TO THE FIRST DESTINATION COMPUTING ENTITY OPERATION 219.

In one embodiment, at TRANSFER THE PROCESSED MESSAGE DATA TO THE FIRST DESTINATION COMPUTING ENTITY OPERATION 219 once the message data is processed, e.g., decrypted, at PROCESS THE MESSAGE DATA USING THE COMMUNICATIONS PROTOCOL PROCESSING DATA OPERATION 217 using the first communications protocol processing data USE THE ENCRYPTION CODE IDENTIFICATION MODULE OF THE COMMUNICATIONS ENDPOINT PROXY SYSTEM TO IDENTIFY THE ENCRYPTION CODE DATA OPERATION 213, the processed message data, i.e., the decrypted message data, is transferred to the first destination computing entity.

In one embodiment, once the processed message data, i.e., the decrypted message data, is transferred to the first destination computing entity at TRANSFER THE PROCESSED MESSAGE DATA TO THE FIRST DESTINATION COMPUTING ENTITY OPERATION 219, process flow proceeds to EXIT OPERATION 230.

In one embodiment, at EXIT OPERATION 230 process 200 for accommodating communications channels using different secure communications protocols is exited to await new data.

Using process 200 for accommodating communications channels using different secure communications protocols, a communications endpoint proxy system is provided that can perform secure communications endpoint proxy message processing functions for multiple secure data transfer protocols, including secure data transfer protocols other than the SSL communications protocol. Consequently, using process 200 for accommodating communications channels using different secure communications protocols, the flexibility, and added security, provided by using multiple secure data transfer protocols, including those other that the SSL communications protocol, is provided.

In one embodiment, multiple communications endpoint proxy systems are provided with each communications endpoint proxy system being assigned a data processing security level such that a given communications endpoint proxy system is provided only message traffic of the data processing security level assigned to the communications endpoint proxy system. In this way, intermingling and potential cross traffic of data of different processing security levels is avoided.

In accordance with one embodiment, a communications endpoint proxy routing system is provided that includes a security level identification capability for identifying a security level associated with received message data.

In one embodiment, two or more communications endpoint proxy systems are provided. In one embodiment, each of the communications endpoint proxy systems is associated with a defined security level of message data and includes a communications protocol processing capability for processing received message data using one or more specific communications protocols associated with that communications endpoint proxy system.

In one embodiment, message data is transferred from a source computing entity to the communications endpoint proxy routing system. In one embodiment, the security level identification capability of the communications endpoint proxy routing system is then used to identify a security level associated with the received message data. The communications endpoint proxy routing system is then used to select a first communications endpoint proxy system of the two or more communications endpoint proxy systems to receive the message data based on the security level associated with the message data and the assigned security level associated with the first communications endpoint proxy system.

In one embodiment, the message data is then transferred from the communications endpoint proxy routing system to the first communications endpoint proxy system. In one embodiment, the communications protocol processing capability of the first communications endpoint proxy system is then used to process the received message data after which the processed message data is transferred to a destination computing entity.

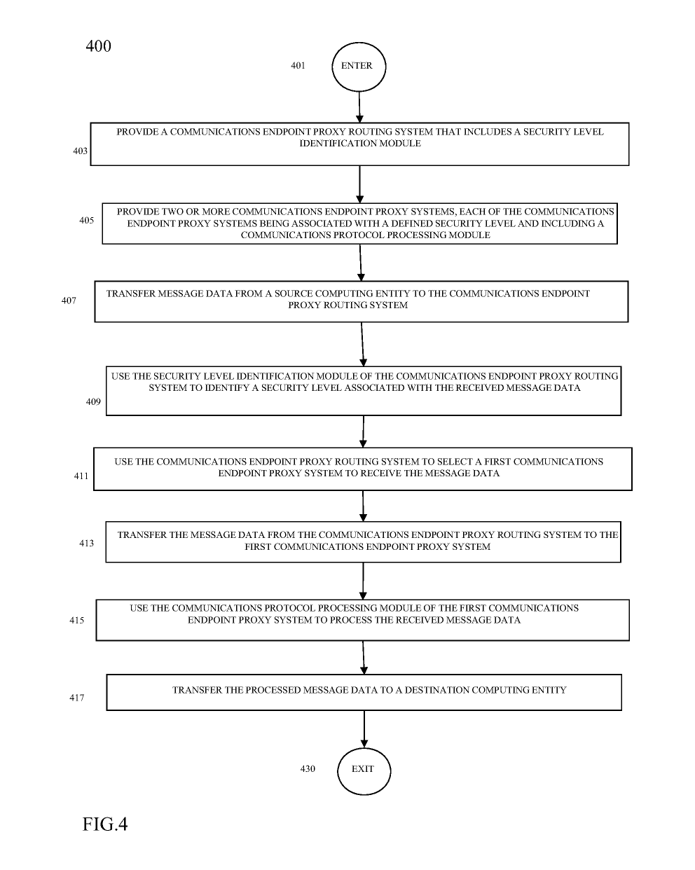

FIG. 4 is a flow chart of a process 400 for accommodating communications channels using different secure communications protocols in accordance with one embodiment. In one embodiment, process 400 for accommodating communications channels using different secure communications protocols begins at ENTER OPERATION 401 of FIG. 4 and process flow proceeds to PROVIDE A COMMUNICATIONS ENDPOINT PROXY ROUTING SYSTEM THAT INCLUDES A SECURITY LEVEL IDENTIFICATION MODULE OPERATION 403.

In one embodiment, at PROVIDE A COMMUNICATIONS ENDPOINT PROXY ROUTING SYSTEM THAT INCLUDES A SECURITY LEVEL IDENTIFICATION MODULE OPERATION 403 a communications endpoint proxy routing system is provided.

In one embodiment the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 includes a security level identification module for identifying a security level associated with received message data and a communications endpoint proxy system designation module for matching the identified security level associated with the received message data to a communications endpoint proxy system having the appropriate assigned processing security level.

In various embodiments, the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 can be any computing system or computing entity, implemented in hardware, software, or any combination of hardware and software, as discussed herein, and/or as known in the art at the time of filing, and/or as developed after the time of filing, capable of identifying a security level associated with received message data and matching the identified security level associated with the received message data to a communications endpoint proxy system having the appropriate assigned processing security level.

In one embodiment, once a communications endpoint proxy routing system is provided at PROVIDE A COMMUNICATIONS ENDPOINT PROXY ROUTING SYSTEM THAT INCLUDES A SECURITY LEVEL IDENTIFICATION MODULE OPERATION 403, process flow proceeds to PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405.

In one embodiment, at PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 two or more communications endpoint proxy systems are provided.

In one embodiment, each of the communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 is associated with a defined security level of message data and includes a communications protocol processing module for processing received message data using one or more specific communications protocols associated with that communications endpoint proxy system.

As discussed below, in one embodiment, each of the communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 is a communications endpoint proxy system similar to those discussed above with respect to FIG. 2 and process 200 for accommodating communications channels using different secure communications protocols.

Returning to FIG. 4, in one embodiment, once two or more communications endpoint proxy systems are provided at PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405, process flow proceeds to TRANSFER MESSAGE DATA FROM A SOURCE COMPUTING ENTITY TO THE COMMUNICATIONS ENDPOINT PROXY ROUTING SYSTEM OPERATION 407.

In one embodiment, at TRANSFER MESSAGE DATA FROM A SOURCE COMPUTING ENTITY TO THE COMMUNICATIONS ENDPOINT PROXY ROUTING SYSTEM OPERATION 407 message data is transferred from a source computing entity to the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403.

In one embodiment, once message data is transferred from a source computing entity to the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 at TRANSFER MESSAGE DATA FROM A SOURCE COMPUTING ENTITY TO THE COMMUNICATIONS ENDPOINT PROXY ROUTING SYSTEM OPERATION 407, process flow proceeds to USE THE SECURITY LEVEL IDENTIFICATION MODULE OF THE COMMUNICATIONS ENDPOINT PROXY ROUTING SYSTEM TO IDENTIFY A SECURITY LEVEL ASSOCIATED WITH THE RECEIVED MESSAGE DATA OPERATION 409.

In one embodiment, at USE THE SECURITY LEVEL IDENTIFICATION MODULE OF THE COMMUNICATIONS ENDPOINT PROXY ROUTING SYSTEM TO IDENTIFY A SECURITY LEVEL ASSOCIATED WITH THE RECEIVED MESSAGE DATA OPERATION 409 the security level identification module of the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 is used to identify a security level associated with the received message data.

In one embodiment, once the security level identification module of the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 is used to identify a security level associated with the received message data at USE THE SECURITY LEVEL IDENTIFICATION MODULE OF THE COMMUNICATIONS ENDPOINT PROXY ROUTING SYSTEM TO IDENTIFY A SECURITY LEVEL ASSOCIATED WITH THE RECEIVED MESSAGE DATA OPERATION 409, process flow proceeds to USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411.

In one embodiment, at USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411 the communications endpoint proxy system designation module of the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 is used select/match a first communications endpoint proxy system of the two or more communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 to receive the message data based on the security level associated with the message data and the assigned security level associated with the first communications endpoint proxy system.

In one embodiment, once the communications endpoint proxy system designation module of the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 is used select/match a first communications endpoint proxy system of the two or more communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 to receive the message data based on the security level associated with the message data and the assigned security level associated with the first communications endpoint proxy system at USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411, process flow proceeds to TRANSFER THE MESSAGE DATA FROM THE COMMUNICATIONS ENDPOINT PROXY ROUTING SYSTEM TO THE FIRST COMMUNICATIONS ENDPOINT PROXY SYSTEM OPERATION 413.

In one embodiment, at TRANSFER THE MESSAGE DATA IS FROM THE COMMUNICATIONS ENDPOINT PROXY ROUTING SYSTEM TO THE FIRST COMMUNICATIONS ENDPOINT PROXY SYSTEM OPERATION 413 the message data is transferred from the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 to the first communications endpoint proxy system of USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411.

In one embodiment, once the message data is transferred from the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 to the first communications endpoint proxy system of USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411 at TRANSFER THE MESSAGE DATA IS FROM THE COMMUNICATIONS ENDPOINT PROXY ROUTING SYSTEM TO THE FIRST COMMUNICATIONS ENDPOINT PROXY SYSTEM OPERATION 413, process flow proceeds to USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415.

In one embodiment, at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415, the communications protocol processing module of the first communications endpoint proxy system of USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411 is used to process the received message data.

In one embodiment, once the communications protocol processing module of the first communications endpoint proxy system of USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411 is used to process the received message data at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415, process flow proceeds to TRANSFER THE PROCESSED MESSAGE DATA TO A DESTINATION COMPUTING ENTITY OPERATION 417.

In one embodiment, at TRANSFER THE PROCESSED MESSAGE DATA TO A DESTINATION COMPUTING ENTITY OPERATION 417 the processed message data is transferred to a destination computing entity.

As noted above, in one embodiment, each of the two or more communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 is a communications endpoint proxy system similar to those discussed above with respect to FIG. 1 and FIG. 2.

Consequently, returning to FIG. 4, in one embodiment, a set of two or more communications protocols are associated with each communications endpoint proxy system of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405. In addition, in one embodiment, the set of two or more communications protocols is open ended and can be added to, or customized, by a given party so long as the selected communications protocol is identified to the system by encryption code data, as discussed below, and communications protocol processing data for processing messages sent using the communications protocol is provided, as also discussed below.

In one embodiment, each communications channel for transferring data, e.g., message data, between a specific source computing entity and a specific destination computing entity is assigned a specific communications protocol. Consequently, in one embodiment, a first communications protocol of the set of two or more communications protocols is selected to be used to transfer message data between a first source computing entity of the one or more source computing entities and a first destination computing entity of the one or more destination computing entities.

In one embodiment, at least one of the communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 is a modified, or multiple protocol enabled, load balancer. As noted above, in order to more efficiently process data and communications, it is desirable to provide various communications endpoint proxy systems, such as, but not limited to, load balancers, to both regulate and distribute communications and processing traffic and to also act as a mechanism for processing message data to perform various functions such as decryption, e.g., act as proxies for secure communications protocol endpoints, in a relatively safe location before the message data is transferred to the actual endpoint, or destination, computing entities for processing.

As also noted above, currently load balancers are typically statically configured to only handle/process the Secure Sockets Layer (SSL) communications protocol.

To address this issue, in one embodiment, each of the two or more communications endpoint proxy systems provided at PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 include an encryption code identification module for identifying the encryption code data associated with the message data and a communications protocol processing module for obtaining communications protocol processing data associated with the first communications protocol identified by encryption code data.

As discussed below, in one embodiment, the encryption code identification module of each of the communications endpoint proxy systems is used to identify and read the encryption code data indicating the selected communications protocol used with message data received by the communications endpoint proxy system. In one embodiment, once the encryption code data is received and identified by the encryption code identification module of the communications endpoint proxy system, the encryption code data is transferred to the communications protocol processing module of the communications endpoint proxy system.

As also discussed below, in one embodiment, the communications protocol processing modules of each of the communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 uses the encryption code data to identify the selected communications protocol and obtain communications protocol processing data associated with the selected communications protocol, e.g., obtain communications protocol processing data indicating how to process/decode message data encoded using the selected communications protocol.

In one embodiment, the communications protocol processing data is transferred to, and stored, on, or under the control of, the communications protocol processing modules of the communications endpoint proxy systems.

In one embodiment, the communications protocol processing data is obtained by the communications protocol processing modules of the communications endpoint proxy systems from a source outside the communications protocol processing modules, such as a data base, or data center, the source computing entity, or the destination computing entity.

In one embodiment, the communications protocol processing data is obtained by the communications protocol processing modules of the communications endpoint proxy systems from a third party source or service outside the communications protocol processing module, such as a digital certificate source or communications protocol provider.

In various embodiments, the communications protocol processing data is obtained by the communications protocol processing modules of the communications endpoint proxy systems from any source of communications protocol processing data as discussed herein, and/or as known in the art at the time of filing, and/or as developed/made available after the time of filing.

In one embodiment, once the communications protocol processing modules of the communications endpoint proxy systems obtain the correct communications protocol processing data for the selected communications protocol identified by the encryption code data, the communications protocol processing modules of the communications endpoint proxy systems process, or direct the processing of, the message data using the correct communications protocol processing data.

In one embodiment, the processing, e.g., decryption, of the message data using the correct communications protocol processing data is performed by the communications protocol processing modules of the communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405.

In one embodiment, the processing, e.g., decryption, of the message data using the correct communications protocol processing data is performed by a computing system or entity outside the communications protocol processing modules of the communications endpoint proxy systems, with the communications protocol processing modules transferring the message data and/or the communications protocol processing data to one or more entities outside the communications protocol processing module.

In one embodiment, the message data to be transferred between the first source computing entity and the first destination computing entity is first transferred from the first source computing entity to the communications endpoint proxy routing system of PROVIDE A COMMUNICATIONS ENDPOINT PROXY ROUTING SYSTEM THAT INCLUDES A SECURITY LEVEL IDENTIFICATION MODULE OPERATION 403 at TRANSFER MESSAGE DATA FROM A SOURCE COMPUTING ENTITY TO THE COMMUNICATIONS ENDPOINT PROXY ROUTING SYSTEM OPERATION 407.

In one embodiment, the security level identification module of the communications endpoint proxy routing system is then used to identify a security level associated with the received message data at USE THE SECURITY LEVEL IDENTIFICATION MODULE OF THE COMMUNICATIONS ENDPOINT PROXY ROUTING SYSTEM TO IDENTIFY A SECURITY LEVEL ASSOCIATED WITH THE RECEIVED MESSAGE DATA OPERATION 409.

The communications endpoint proxy routing system is then used at USE THE COMMUNICATIONS ENDPOINT PROXY ROUTING SYSTEM TO SELECT A FIRST COMMUNICATIONS ENDPOINT PROXY SYSTEM TO RECEIVE THE MESSAGE DATA OPERATION 411 to select a first communications endpoint proxy system of the two or more communications endpoint proxy systems of PROVIDE TWO OR MORE COMMUNICATIONS ENDPOINT PROXY SYSTEMS, EACH OF THE COMMUNICATIONS ENDPOINT PROXY SYSTEMS BEING ASSOCIATED WITH A DEFINED SECURITY LEVEL AND INCLUDING A COMMUNICATIONS PROTOCOL PROCESSING MODULE OPERATION 405 to receive the message data based on the security level associated with the message data and the assigned security level associated with the first communications endpoint proxy system.

In one embodiment, the message data is then transferred from the communications endpoint proxy routing system to the selected first communications endpoint proxy of the one or more communications endpoint proxies at TRANSFER THE MESSAGE DATA IS FROM THE COMMUNICATIONS ENDPOINT PROXY ROUTING SYSTEM TO THE FIRST COMMUNICATIONS ENDPOINT PROXY SYSTEM OPERATION 413. As noted above, at the first communications endpoint proxy, the first communications endpoint proxy encryption code identification module identifies the encryption code data associated with the message data.

As also noted above, in one embodiment, at the communications protocol processing module of the first communications endpoint proxy system then uses the encryption code data associated with the message data to identify the selected first communications protocol and obtain first communications protocol processing data associated with the first communications protocol, e.g., obtain first communications protocol processing data indicating how to process/decode the message data encoded using the first communications protocol.

As noted above, in one embodiment, the communications protocol processing data is pre-deployed, or transferred to, and stored on, or under the control of, the communications protocol processing module of the first communications endpoint proxy system. In this embodiment, the first communications protocol processing data is simply identified and obtained from within the communications protocol processing module of the first communications endpoint proxy system.

As also noted above, in one embodiment, the first communications protocol processing data is obtained by the communications protocol processing module of the first communications endpoint proxy system from a source outside the communications protocol processing module, such as a database, or data center, the first source computing entity, or the first destination computing entity.

As noted above, in one embodiment, the first communications protocol processing data is obtained by the communications protocol processing module of the first communications endpoint proxy system from a third party source or service outside the communications protocol processing module, such as a digital certificate source or communications protocol provider.

In various embodiments, the first communications protocol processing data is obtained by the communications protocol processing module of the first communications endpoint proxy system from any source of communications protocol processing data as discussed herein, and/or as known in the art at the time of filing, and/or as developed/made available after the time of filing.

As discussed above, in one embodiment, once the communications protocol processing module of the first communications endpoint proxy system obtains the correct first communications protocol processing data for the selected first communications protocol identified by the encryption code data associated with the message data, the communications protocol processing module of the first communications endpoint proxy system processes, or directs the processing of, the message data using the first communications protocol processing data at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415.

In one embodiment, the processing, e.g., decryption, of the message data using the first communications protocol processing data is performed by the communications protocol processing module of the first communications endpoint proxy system itself at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415.

In one embodiment, the processing, e.g., decryption, of the message data using the first communications protocol processing data is performed at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415 by a computing system or entity outside the communications protocol processing module of the first communications endpoint proxy system, with the communications protocol processing module transferring the message data and/or the first communications protocol processing data to one or more entities outside the communications protocol processing module.

In one embodiment, once the message data is processed, e.g., decrypted, using the first communications protocol processing data at USE THE COMMUNICATIONS PROTOCOL PROCESSING MODULE OF THE FIRST COMMUNICATIONS ENDPOINT PROXY SYSTEM TO PROCESS THE RECEIVED MESSAGE DATA OPERATION 415, the processed message data, i.e., the decrypted message data, is transferred to the first destination computing entity at TRANSFER THE PROCESSED MESSAGE DATA TO A DESTINATION COMPUTING ENTITY OPERATION 417.

In one embodiment, once the processed message data is transferred to a destination computing entity at TRANSFER THE PROCESSED MESSAGE DATA TO A DESTINATION COMPUTING ENTITY OPERATION 417, process flow proceeds to EXIT OPERATION 430.

In one embodiment, at EXIT OPERATION 430 process 400 for accommodating communications channels using different secure communications protocols is exited to await new data.

Using process 400 for accommodating communications channels using different secure communications protocols, multiple communications endpoint proxy systems are provided with each communications endpoint proxy system being assigned a data processing security level such that a given communications endpoint proxy system is provided only message traffic of the data processing security level assigned to the communications endpoint proxy system. In this way, intermingling and potential cross traffic of data of different processing security levels is avoided.

In addition, in one embodiment, using process 400 for accommodating communications channels using different secure communications protocols, each communications endpoint proxy system can perform secure communications endpoint proxy message processing functions for multiple secure data transfer protocols, including secure data transfer protocols other than the SSL communications protocol. Consequently, using process 400 for accommodating communications channels using different secure communications protocols, the flexibility, and added security, provided by using multiple secure data transfer protocols, including those other that the SSL communications protocol, is provided.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature often used in the art to identify equivalent operations.

Therefore, numerous variations, whether explicitly provided for by the specification or implied by the specification or not, may be implemented by one of skill in the art in view of this disclosure.

What is claimed is:

1. A system for accommodating communications channels using different secure communications protocols:
at least one processor; and
at least one memory coupled to the at least one processor, the at least one memory having stored therein instructions which when executed by any set of the one or more processors, perform a process for accommodating communications channels using different secure communications protocols, the process for accommodating communications channels using different secure communications protocols including:
providing a set of two or more communications protocols to be used to transfer message data between one or more source computing entities and one or more destination computing entities;
providing a communications endpoint proxy system, the communications endpoint proxy system including an encryption code identification module for identifying encryption code data associated with received message data, the encryption code data being associated with a communications protocol to be used with the message data, the communications endpoint proxy system further including a communications protocol processing module for obtaining communications protocol processing data associated with identified encryption code data and processing the received message data using the communications protocol processing data;
selecting a communications protocol of the set of two or more communications protocols to be used to transfer message data between a first source computing entity of the one or more source computing entities and a first destination computing entity of the one or more destination computing entities;
generating encryption code data identifying the selected communications protocol and associating the encryption code data with the message data to be transferred between the first source computing entity and the first destination computing entity;
providing the encryption code data identifying the selected communications protocol to be used for the message data to be transferred between the first source computing entity and the first destination computing entity to the communications endpoint proxy system;
using the encryption code identification module of the communications endpoint proxy system to identify the encryption code data;
using the communications protocol processing module to obtain communications protocol processing data associated with identified encryption code data;
processing the message data to be transferred between the first source computing entity and the first destination computing entity using the communications protocol processing data; and
transferring the processed message data to the first destination computing entity.

2. The system for accommodating communications channels using different secure communications protocols of claim 1 wherein at least one of the two or more communications protocols is a communications protocol other than a Secure Sockets Layer (SSL) communications protocol.

3. The system for accommodating communications channels using different secure communications protocols of claim 1 wherein the one or more source computing entities are implemented in a first computing environment and the one or more destination computing entities are implemented in a second computing environment that is distinct from the first computing environment.

4. The system for accommodating communications channels using different secure communications protocols of claim 1 wherein the one or more source computing entities are virtual assets implemented in a first cloud computing environment and the one or more destination computing entities are implemented in a second computing environment that is distinct from the first cloud computing environment.

5. The system for accommodating communications channels using different secure communications protocols of claim 4 wherein at least one of the virtual assets is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

6. The system for accommodating communications channels using different secure communications protocols of claim 1 wherein the communications endpoint proxy system is a multiple protocol enabled load balancer.

7. The system for accommodating communications channels using different secure communications protocols of claim 1 wherein the encryption code data identifying the selected communications protocol is included in a message header of the message data to be transferred between the first source computing entity and the first destination computing entity.

8. The system for accommodating communications channels using different secure communications protocols of claim 1 wherein the encryption code data identifying the selected communications protocol is included in a packet header of at least part of the message data to be transferred between the first source computing entity and the first destination computing entity.

9. The system for accommodating communications channels using different secure communications protocols of claim 1 wherein the encryption code data identifying the selected communications protocol is provided to the communications endpoint proxy system separately from the message data to be transferred between the first source computing entity and the first destination computing entity.

10. The system for accommodating communications channels using different secure communications protocols of claim 1 wherein at least part of the communications protocol processing data is located within the communications endpoint proxy system.

11. The system for accommodating communications channels using different secure communications protocols of claim 1 wherein at least part of the communications protocol processing data is obtained from a communications protocol processing data source outside the communications endpoint proxy system.

12. The system for accommodating communications channels using different secure communications protocols of claim 1 wherein at least part of the communications protocol processing data is obtained from a third party communications protocol processing data source.

13. A system for accommodating communications channels using different secure communications protocols:
one or more source computing entities;
one or more destination computing entities;
a set of two or more communications protocols to be used to transfer message data between the one or more source computing entities and the one or more destination computing entities;
a communications endpoint proxy system, the communications endpoint proxy system including an encryption code identification module for identifying encryption code data associated with received message data, the encryption code data being associated with a communications protocol to be used with the message data, the communications endpoint proxy system further including a communications protocol processing module for obtaining communications protocol processing data associated with identified encryption code data and processing the received message data using the communications protocol processing data;
a first source computing entity selected from the one or more source computing entities;
a first destination computing entity selected from the one or more destination computing entities;
message data to be transferred between the first source computing entity and the first destination computing entity;
a selected communications protocol of the set of two or more communications protocols selected to be used to transfer the message data between the first source computing entity and the first destination computing entity;
encryption code data identifying the selected communications protocol and associated with the message data to be transferred between the first source computing entity and the first destination computing entity;
a communications channel for providing the encryption code data to the encryption code identification module of the communications endpoint proxy system to identify the encryption code data;
a communications channel for using the communications protocol processing module of the communications endpoint proxy system to obtain communications protocol processing data associated with identified encryption code data to process the message data to be transferred between the first source computing entity and the first destination computing entity using the communications protocol processing data; and
a communications channel for transferring the processed message data to the first destination computing entity.

14. The system for accommodating communications channels using different secure communications protocols of claim 13 wherein at least one of the two or more communications protocols is a communications protocol other than a Secure Sockets Layer (SSL) communications protocol.

15. The system for accommodating communications channels using different secure communications protocols of claim 13 wherein the one or more source computing entities are implemented in a first computing environment and the one or more destination computing entities are implemented in a second computing environment that is distinct from the first computing environment.

16. The system for accommodating communications channels using different secure communications protocols of claim 13 wherein the one or more source computing entities are virtual assets implemented in a first cloud computing environment and the one or more destination computing entities are implemented in a second computing environment that is distinct from the first cloud computing environment.

17. The system for accommodating communications channels using different secure communications protocols of claim 16 wherein at least one of the virtual assets is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

18. The system for accommodating communications channels using different secure communications protocols of claim 13 wherein the communications endpoint proxy system is a multiple protocol enabled load balancer.

19. The system for accommodating communications channels using different secure communications protocols of claim 13 wherein the encryption code data identifying the selected communications protocol is included in a message header of the message data to be transferred between the first source computing entity and the first destination computing entity.

20. The system for accommodating communications channels using different secure communications protocols of claim 13 wherein the encryption code data identifying the selected communications protocol is included in a packet header of at least part of the message data to be transferred between the first source computing entity and the first destination computing entity.

21. The system for accommodating communications channels using different secure communications protocols of claim 13 wherein the encryption code data identifying the selected communications protocol is provided to the communications endpoint proxy system separately from the message data to be transferred between the first source computing entity and the first destination computing entity.

22. The system for accommodating communications channels using different secure communications protocols of claim 13 wherein at least part of the communications protocol processing data is located within the communications endpoint proxy system.

23. The system for accommodating communications channels using different secure communications protocols of claim 13 wherein at least part of the communications protocol processing data is obtained from a communications protocol processing data source outside the communications endpoint proxy system.

24. The system for accommodating communications channels using different secure communications protocols of claim 13 wherein at least part of the communications protocol processing data is obtained from a third party communications protocol processing data source.

25. A system for accommodating communications channels using different secure communications protocols:
at least one processor; and
at least one memory coupled to the at least one processor, the at least one memory having stored therein instructions which when executed by any set of the one or more processors, perform a process for accommodating communications channels using different secure communications protocols, the process for accommodating communications channels using different secure communications protocols including:
providing a set of two or more communications protocols to be used to transfer message data between one or more source computing entities and one or more destination computing entities;
providing a communications endpoint proxy routing system, the communications endpoint proxy routing system including security level identification module for identifying a security level associated with received message data;
providing two or more communications endpoint proxy systems, each of the communications endpoint proxy systems being associated with a defined security level associated with received message data, each of the communications endpoint proxy systems including an encryption code identification module for identifying encryption code data associated with received message data, the encryption code data being associated with a communications protocol to be used with the message data, each of the communications endpoint proxy systems further including a communications protocol processing module for obtaining communications protocol processing data associated with identified encryption code data and processing the received message data using the communications protocol processing data;
selecting a communications protocol of the set of two or more communications protocols to be used to transfer message data between a first source computing entity of the one or more source computing entities and a first destination computing entity of the one or more destination computing entities;
generating encryption code data identifying the selected communications protocol and associating the encryption code data with the message data to be transferred between the first source computing entity and the first destination computing entity;
providing the encryption code data identifying the selected communications protocol to be used for the message data to be transferred between the first source computing entity and the first destination computing entity to the communications endpoint proxy system;
using the communications endpoint proxy routing system to select a first communications endpoint proxy system of the one or more communications endpoint proxy systems to receive the message data to be transferred between the first source computing entity and the first destination computing entity, the a first communications endpoint proxy system being selected based on a security level associated with message data;
transferring the message data to the first communications endpoint proxy system;
using the encryption code identification module of the first communications endpoint proxy system to identify the encryption code data;
using the communications protocol processing module of the first communications endpoint proxy system to obtain communications protocol processing data associated with identified encryption code data;
processing the message data to be transferred between the first source computing entity and the first destination computing entity using the communications protocol processing data; and
transferring the processed message data to the first destination computing entity.

26. The system for accommodating communications channels using different secure communications protocols of claim 25 wherein at least one of the two or more communications protocols is a communications protocol other than a Secure Sockets Layer (SSL) communications protocol.

27. The system for accommodating communications channels using different secure communications protocols of claim 25 wherein the one or more source computing entities are implemented in a first computing environment and the one or more destination computing entities are implemented in a second computing environment that is distinct from the first computing environment.

28. The system for accommodating communications channels using different secure communications protocols of claim 25 wherein the one or more source computing entities are virtual assets implemented in a first cloud computing environment and the one or more destination computing entities are implemented in a second computing environment that is distinct from the first cloud computing environment.

29. The system for accommodating communications channels using different secure communications protocols of claim 28 wherein at least one of the virtual assets is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

30. The system for accommodating communications channels using different secure communications protocols of claim 25 wherein the at least one of the two or more communications endpoint proxy systems is a multiple protocol enabled load balancer.

31. The system for accommodating communications channels using different secure communications protocols of claim 25 wherein the security level identification module of the communications endpoint proxy routing system identifies a security level associated received message data based on data in a header of the message data.

32. The system for accommodating communications channels using different secure communications protocols of claim 25 wherein the security level identification module of the communications endpoint proxy routing system identifies a security level associated received message data based on the content of the message data.

33. The system for accommodating communications channels using different secure communications protocols of claim 25 wherein the security level identification module of the communications endpoint proxy routing system identifies a security level associated received message data based on the source entity associated with the message data.

34. The system for accommodating communications channels using different secure communications protocols of claim 25 wherein the security level identification module of the communications endpoint proxy routing system identifies a security level associated received message data based on the destination entity associated with of the message data.

35. The system for accommodating communications channels using different secure communications protocols of claim 25 wherein the encryption code data identifying the selected communications protocol is included in a message header of the message data to be transferred between the first source computing entity and the first destination computing entity.

36. The system for accommodating communications channels using different secure communications protocols of claim 25 wherein the encryption code data identifying the selected communications protocol is included in a packet header of at least part of the message data to be transferred between the first source computing entity and the first destination computing entity.

37. The system for accommodating communications channels using different secure communications protocols of claim 25 wherein the encryption code data identifying the selected communications protocol is provided to the communications endpoint proxy system separately from the message data to be transferred between the first source computing entity and the first destination computing entity.

38. The system for accommodating communications channels using different secure communications protocols of claim 25 wherein at least part of the communications protocol processing data is located within the communications endpoint proxy system.

39. The system for accommodating communications channels using different secure communications protocols of claim 25 wherein at least part of the communications protocol processing data is obtained from a communications protocol processing data source outside the communications endpoint proxy system.

40. The system for accommodating communications channels using different secure communications protocols of claim 25 wherein at least part of the communications protocol processing data is obtained from a third party communications protocol processing data source.

41. A system for accommodating communications channels using different secure communications protocols:
at least one processor; and
at least one memory coupled to the at least one processor, the at least one memory having stored therein instructions which when executed by any set of the one or more processors, perform a process for accommodating communications channels using different secure communications protocols, the process for accommodating communications channels using different secure communications protocols including:
providing a communications endpoint proxy routing system, the communications endpoint proxy routing system including security level identification module for identifying a security level associated with received message data;
providing two or more communications endpoint proxy systems, each of the communications endpoint proxy systems being associated with a defined security level associated with message data, each of the communications endpoint proxy systems including a communications protocol processing module for processing received message data using a communications protocol associated with that communications endpoint proxy system;
the communications endpoint proxy routing system receiving message data from a source computing entity;
using the security level identification module of the communications endpoint proxy routing system to identify a security level associated with the received message data;
using the communications endpoint proxy routing system to select a first communications endpoint proxy system of the two or more communications endpoint proxy systems to receive the message data based on the security level associated with the message data and the defined security level associated with the first communications endpoint proxy system;
transferring the message data to the first communications endpoint proxy system;
using the communications protocol processing module of the first communications endpoint proxy system to process the received message data; and
transferring the processed message data to a first destination computing entity.

42. The system for accommodating communications channels using different secure communications protocols of claim 41 wherein the source computing entity is implemented in a first computing environment and the destination computing entity is implemented in a second computing environment that is distinct from the first computing environment.

43. The system for accommodating communications channels using different secure communications protocols of claim 41 wherein the source computing entity is a virtual asset implemented in a first cloud computing environment and destination computing entity is implemented in a second computing environment that is distinct from the first cloud computing environment.

44. The system for accommodating communications channels using different secure communications protocols of claim 43 wherein the virtual asset is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

45. The system for accommodating communications channels using different secure communications protocols of claim 41 wherein the at least one of the two or more communications endpoint proxy systems is a load balancer.

46. The system for accommodating communications channels using different secure communications protocols of claim 41 wherein the security level identification module of the communications endpoint proxy routing system identifies a security level associated received message data based on data in a header of the message data.

47. The system for accommodating communications channels using different secure communications protocols of claim 41 wherein the security level identification module of the communications endpoint proxy routing system identifies a security level associated received message data based on the content of the message data.

48. The system for accommodating communications channels using different secure communications protocols of claim 41 wherein the security level identification module of the communications endpoint proxy routing system identifies a security level associated received message data based on the source entity associated with the message data.

49. The system for accommodating communications channels using different secure communications protocols of claim 41 wherein the security level identification module of the communications endpoint proxy routing system identifies a security level associated received message data based on the destination entity associated with of the message data.
